(19) United States
(12) Patent Application Publication
(10) Pub. No.: US 2026/0155986 A1
(43) Pub. Date: Jun. 4, 2026

(54) METHODS AND SYSTEMS FOR VERIFYING A USER ACROSS MULTIPLE DOMAINS

(71) Applicant: Kabushiki Kaisha Toshiba, Tokyo (JP)

(72) Inventors: Timothy David FARNHAM, Bristol (GB); Christina KARAKOSTA, Bristol (GB)

(73) Assignee: Kabushiki Kaisha Toshiba, Tokyo (JP)

(21) Appl. No.: 18/964,116

(22) Filed: Nov. 29, 2024

(51) Int. Cl. H04L 9/32

(52) U.S. Cl. CPC H04L 9/3236; H04L 9/3213

(57) ABSTRACT

A computer-implemented method comprising: receiving, by a first domain attribute database from a user device, first data; determining, based on the first data, a value of a location-dependent parameter for the user device; computing, by the first domain attribute database, a first hashID for a user of the user device, based on the value of the location-dependent parameter; mapping, by the first domain attribute database, the first hashID to one or more user attributes stored in the first domain attribute database; receiving, by the first domain attribute database from an authenticator for the first domain, a lookup request comprising a second hashID; in the event that the first domain attribute database determines the second hashID to match the first hashID, using the mapping between the first hashID and the one or more stored user attributes to return the one or more stored user attributes.

### FIELD

Embodiments described herein relate to methods and systems for verifying a user across multiple domains.

### BACKGROUND

Personalised cross-domain services need to access user attributes that are stored in different data sources within different domains. They typically use a federated identity server configuration in which an identity in one domain is mapped to another by exchanging identity tokens (ID tokens) between the servers. The ID tokens contain attributes—such as an email address, for example—that can be used to map identities to share relevant information. Currently, however, there is no common standard for what attributes to use or how they are verified. Moreover, if the attributes contain specific personal information that can be used to identify a user, this cannot normally be performed without anonymization using hashing or similar techniques, thereby making mapping harder without universally consistent data.

Since attributes and their verification are not specified, there may be no common attributes available between domains or multiple matches if they are not unique. For instance, with reference to FIG. 1, a user can be identified by an email address (or a passport number etc.) and associated with a browser or otherwise derived UUID in a first domain A. However, the domains A and B may not have the same attribute data related to each user to map them across domains. If Domain B has no email attribute, the email address used to obtain access to resources in domain A will not allow that user to access resources in domain B. Modern browsers also do not allow personal identification information or third-party cookies to be passed between domains (or even used at all), making it hard for cross-domain web applications to share a common universal identity for the user.

Open ID Connect (OIDC) is a protocol that facilitates the exchange of ID tokens between domains but does not specify or mandate the use of common or unique attributes. FIG. 2A shows an example of an OIDC browser user provisioning/login sequence using the federated identity provider (IdP) “Keycloak”. In this case, a user seeks to login to an application (Domain A) using a browser (step S201). Upon receiving the login request, the application generates an authentication request and redirects the user to the Keycloak IdP (steps S203-S207). The user enters their credentials to the Keycloak IdP (step S209) and following the authentication of the credentials by the Keycloak IdP (step S211), the IdP generates an authorization code that is sent to the user (step S213). The user communicates the authorization code to the local (Domain A) authenticator (step S215). The Domain A authenticator uses the code to obtain a unique ID token from the Keycloak IdP (steps S217, S219). In steps S221 and S223, the Domain A authenticator authenticates the user by looking up the relevant attributes in the Domain A attribute database (DB); that is, the Domain A authenticator performs a lookup using attributes from the ID token to match with the attributes in the attribute database. Having successfully identified the user and matched with a local user ID, the authenticator then provides the user with an access token (step S225), allowing the user to access the client Domain A (steps S227, S229).

Turning to FIG. 2B, this shows the continuation of the process shown in FIG. 2A, with the user now seeking to login into a second client domain, Domain B. As before, the user sends the login request to Domain B, upon which that domain redirects the user to the Keycloak IdP (steps S231, S233). The user provides their credentials to the Keycloak IdP (step S235). Since the IdP has already authenticated the credentials in the earlier step S211, there is no need to repeat the authentication here. Instead, the IdP proceeds directly to generate an authorization code that is sent to the user (step S237). The user communicates the authorization code to the local (Domain B) authenticator (step S239). The Domain B authenticator uses the code to obtain an ID token from the Keycloak IdP (steps S241, S243), the contents of the token being the same as that in steps S217, S219 of FIG. 2A when accessing domain A. In steps S245 and S247, the Domain B authenticator authenticates the user by looking up the relevant attributes in the Domain B attribute database (DB); that is, the Domain B authenticator performs a lookup using attributes from the ID token to match with the attributes in the attribute database. Having successfully identified the user and matched with a local user ID, the authenticator then provides the user with an access token (step S249), allowing the user to access the client Domain B (steps S251, S253).

FIG. 3 shows an example of the ID token exchanged between the IdP Keycloak and the domain authenticators in the conventional method of FIG. 2. As can be seen, in this example, the ID token includes user personal identification attributes such as the user name (James Smith) and email address (JamesS@university.com). These attributes enable the domain authenticators to perform the lookup in the respective attribute databases.

The method shown in FIGS. 2A, 2B and 3 requires that the user have at least one attribute that is common to the two domains and also unique to that user. Missing or inconsistently recorded attributes can occur, however, due to mistakes or omissions and formatting variations, such as capitalisation and white space or ordering. Users may also have multiple email addresses/multiple addresses or passport and ID numbers, and different domains may have different subsets of these and may not be permitted to share even anonymised hashes of them due to privacy regulations and user preferences. If the attribute information contained in the ID token is not available locally to the authenticator, then a new identity must be provisioned that duplicates a user in the local domain. Alternatively, if there are multiple matches for the name contained in the ID token, it will not be possible to uniquely map the user identity and the login will likely fail.

### BRIEF DESCRIPTION OF DRAWINGS

Embodiments of the invention will now be described by way of example with reference to the accompanying drawings in which:

FIG. 1 shows an example of how a user verified by a first domain may fail to be verified in a second domain, in a conventional system;

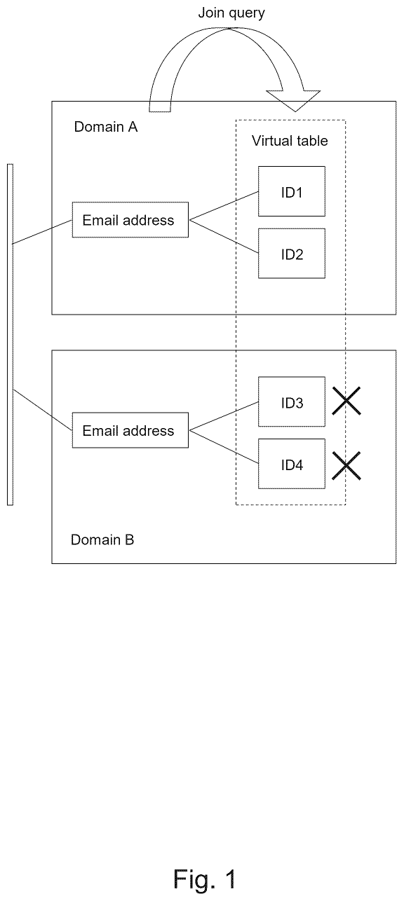

FIG. 2A shows an example of an OIDC browser user provisioning/login sequence using a federated identity provider (IdP) in a conventional system;

FIG. 2B shows the continuation of the process shown in FIG. 2A;

FIG. 3 shows an example of the ID token exchanged between the IdP and the domain authenticators in FIGS. 2A and 2B;

FIG. 4A shows the steps carried out in verifying a user in a method according to an embodiment;

FIG. 4B shows a continuation of steps carried out in the method of FIG. 4A;

FIG. 5 shows an example of an access token as used in the embodiment of FIGS. 4A and 4B;

FIG. 6 shows an example sequence of code for anonymously updating the location data in a method according to an embodiment; and

FIG. 7 shows a how the performance of queries in an embodiment using a distributed database proxy compares to the case without such a proxy.

### DETAILED DESCRIPTION

According to an embodiment, there is provided a computer-implemented method comprising:
receiving, by a first domain attribute database from a user device, first data;
determining, based on the first data, a value of a location-dependent parameter for the user device;
computing, by the first domain attribute database, a first hashID for a user of the user device, based on the value of the location-dependent parameter;
mapping, by the first domain attribute database, the first hashID to one or more user attributes stored in the first domain attribute database;
receiving, by the first domain attribute database from an authenticator for the first domain, a lookup request comprising a second hashID;

in the event that the first domain attribute database determines the second hashID to match the first hashID, using the mapping between the first hashID and the one or more stored user attributes to return the one or more stored user attributes.

The method may comprise forwarding, by the authenticator for the first domain to the user device, an access token with which to access the first domain.

The first hashID may be computed by the first domain attribute database using the value of the location-dependent parameter and a timestamp indicating a time of receipt of the value of the location-dependent parameter by the first domain attribute database.

The method may further comprise:
receiving, by the first domain attribute database, at a later point in time, an updated value of the location-dependent parameter for the user device; and
re-computing the first hashID using the updated value of the location-dependent parameter.

The re-computed first hashID may be computed using the updated value of the location-dependent parameter and a timestamp indicating a time of receipt of the updated value of the location-dependent parameter by the first domain attribute database.

In the event that the first domain attribute database fails to match the second hashID with the first hashID or any other previously received hashID, the method may comprise:
issuing, by the authenticator for the first domain, a request for an ID token from a federated identity provider with whom the user has previously authenticated themselves;
receiving, by the authenticator for the first domain, the ID token and;
performing, by the identity provider, a location update using the first hashID on the first domain attribute database; and
performing, by the first domain attribute database, a lookup of the one or more stored user attributes using the hashID attributes from the ID token; and
returning, by the first domain attribute database, the one or more stored user attributes to the authenticator for the first domain.

The method may further comprise: receiving, by the first domain attribute database from the federated identity provider, an updated value of the location-dependent parameter for the user device.

According to an embodiment, there is provided a computer-implemented method comprising:
providing, by a user of a user device to a federated identity provider, user authentication credentials and a value of a location-dependent parameter;
receiving, by the user device from the federated identity provider, and in response to being authenticated by the federated identity provider, a first hashID, the first hashID being computed based on the value of the location-dependent parameter;
forwarding, by the user device, the first hashID to an authenticator for a first domain; and
receiving, from the authenticator for the first domain, an access token with which to access the first domain.

The first hashID may be computed based on the location data and a time at which the value of the location-dependent parameter was forwarded to the federated identity provider.

The method may further comprise:
providing, by the user of a user device to the federated identity provider at a subsequent point in time, an updated value of the location-dependent parameter;
receiving, by the user device from the federated identity provider, a second hashID, the second hashID being computed based on the updated value of the location-dependent parameter;
forwarding, by the user device, the second hashID to an authenticator for a second domain; and
receiving, from the authenticator for the second domain, an access token with which to access the second domain.

The second hashID may be computed based on the updated value of the location-dependent parameter and a time at which the updated value of the location-dependent parameter was forwarded to the federated identity provider.

The value of the location-dependent parameter may be propagated to the first domain attribute database via a network hosting a distributed ledger.

According to an embodiment, there is provided a computer system comprising one or more computing devices configured to execute a method according to any one of the above embodiments above.

According to an embodiment, there is provided a non-transitory computer readable medium comprising computer executable instructions that when executed by one or more computing devices will cause the one or more computing devices to carry out a method according to any one of the embodiments above.

Embodiments described herein exploit information about a user's location to verify that user's identity in different domains. The mapping of identities across these domains can also enable aggregation of user attributes to support promotions and other applications that need to consider aggregated user behaviours.

Embodiments can be integrated with existing federated identity services, using Open ID Connect, for example, to allow cross-domain verification and mapping of a user's identity by obtaining and sharing the values of one or more location dependent properties for the user device or multiple user devices. The user device(s) may comprise one or more smart phones, laptops, tablets, or other computing devices, for example.

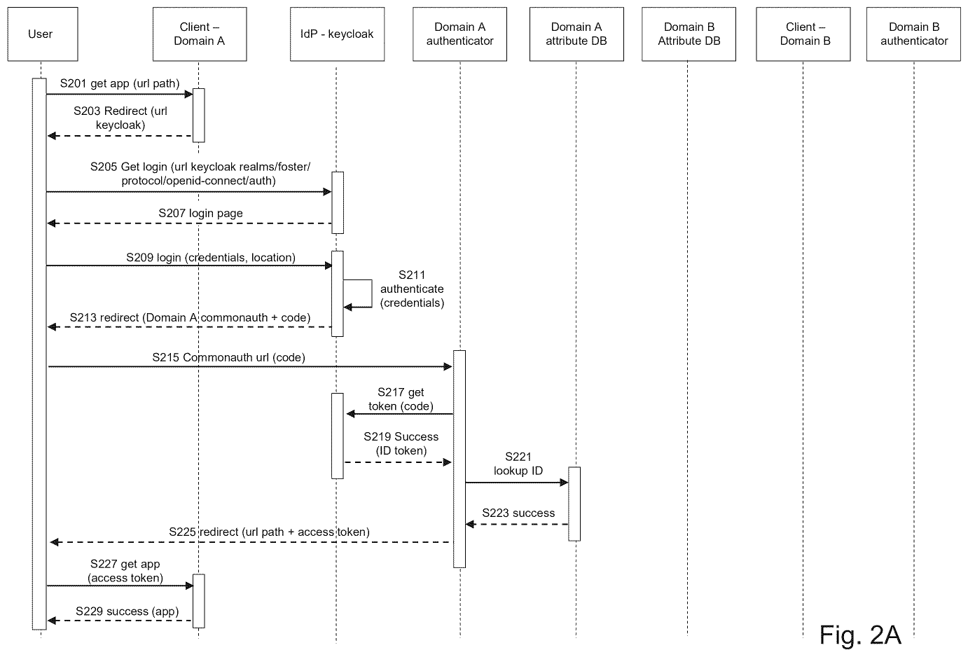

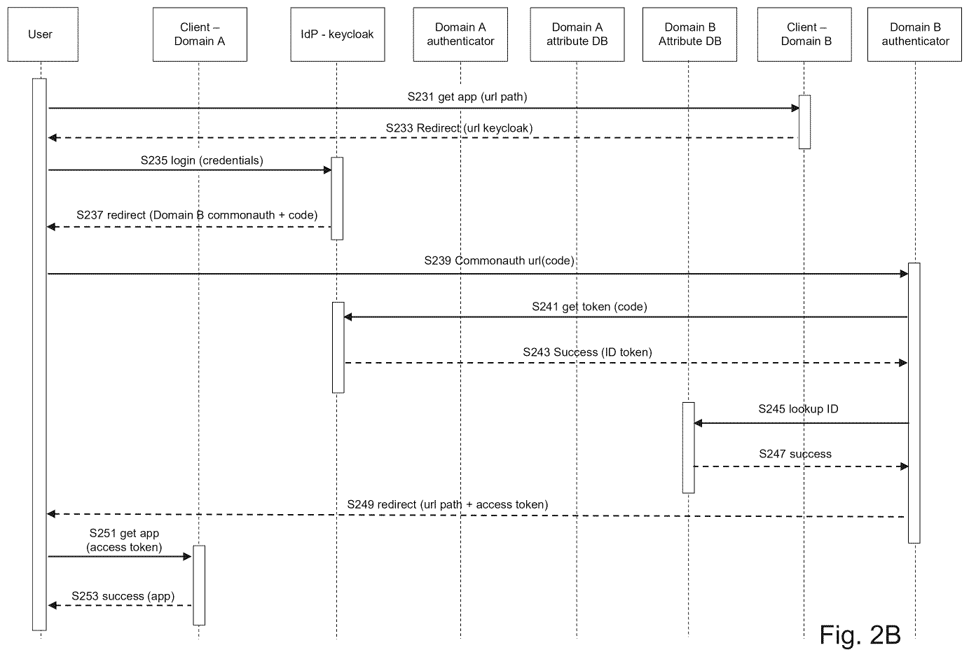

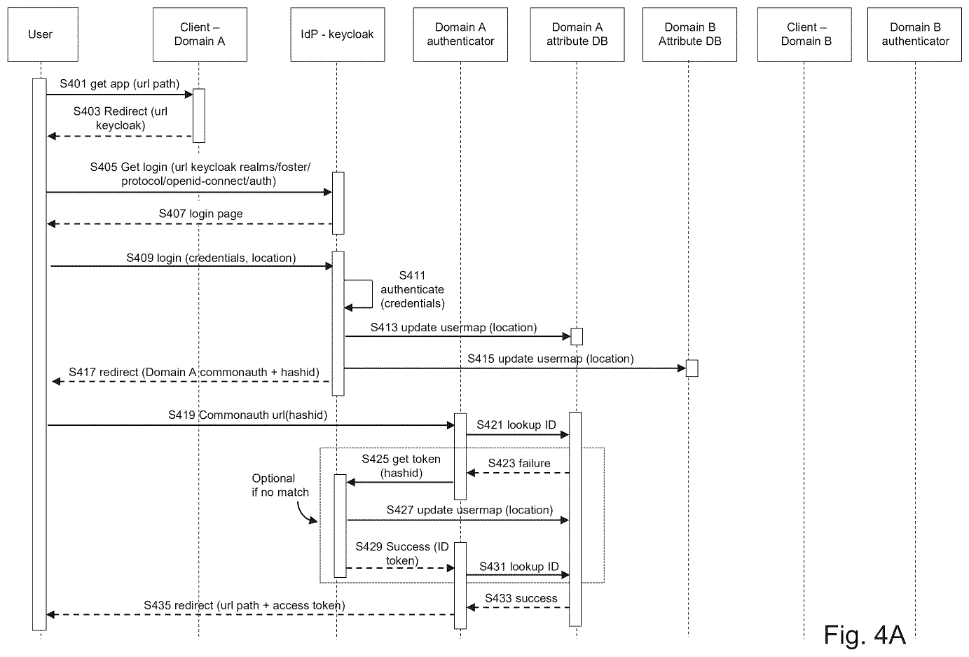

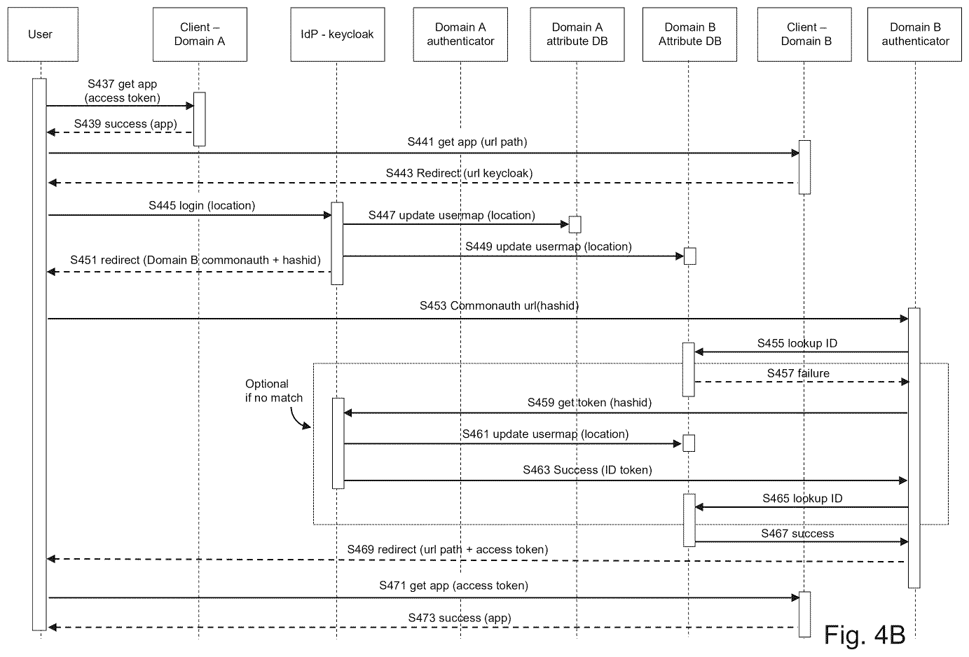

FIGS. 4A and 4B show the steps carried out in a method according to an embodiment. In this embodiment, the IdP Keycloak is again used as a means to perform federated service login through a browser. In contrast to the conventional approach shown in FIGS. 2A, 2B, however, the login process of FIGS. 4A, 4B uses location information obtained within one domain to permit verification of the mapping of user attributes across different domains without revealing the true user identity attributes (such as names, email addresses or passport numbers) to the domain participants (e.g. third-party promotion applications and services) via the ID and access tokens.

The process shown in FIG. 4A begins in the same way as in FIG. 2A, with the user logging into a first local domain (Domain A) by providing login credentials (username, password) to the IdP Keycloak (steps S401 to S411). When doing so, the user agent also supplies first data to the IdP (step S409). The first data comprises data that can be used to determine the value of a parameter that is dependent on the device location, and which will vary as the location varies. In some embodiments, the first data explicitly defines or mentions the user device location; for example, the first data may comprise GPS coordinates for the user device. In other embodiments, the first data comprises a measured value for one or other phenomena such as magnetic field strength, accelerometer readings, or radio signal strength, where those measurements are correlated with a particular geographic location.

The first data is forwarded to the Domain A attribute database (DB) (step S413) as well as the Domain B attribute database (DB) (step S415). The first data may be obtained from the mobile application or web application (such as login page) that the user is presently operating through a geolocation interface. The first data may be obtained via a background JavaScript that is loaded in the page header of the login page. Upon receipt of the first data, the domain A attribute database and domain B attribute database update their stored user location attributes with value of the location-dependent parameter, as derived from the first data. Each attribute database also applies a timestamp to the received data, indicating the time it was received. The time may be obtained from the clock of the computer system used to host the attribute database storage and may be measured using a suitable quantised resolution epoch such as minutes or seconds from an origin reference e.g. 1 Jan. 1970.

The domain A attribute database and the domain B attribute database each use the latest value of the location-dependent parameterto compute a hashID for the user. The hashID may be computed by passing the value (and optionally, the timestamp) through a one-way hash function. Once computed, the hashID is mapped to local user attribute tables within each domain attribute database using a usermap stored by the database. The usermap itself is a separate table in each domain attribute database that is not virtualised, whilst the user attribute tables are virtualised so that they appear as a single table of user attributes. In steps S413 and S415, the usermap for each domain attribute database is updated with the newly computed hashID.

Following the authentication of the user credentials by the IdP, the user receives an authorization code from the IdP (step S417). The IdP also provides the hashID to the user along with the authorization code.

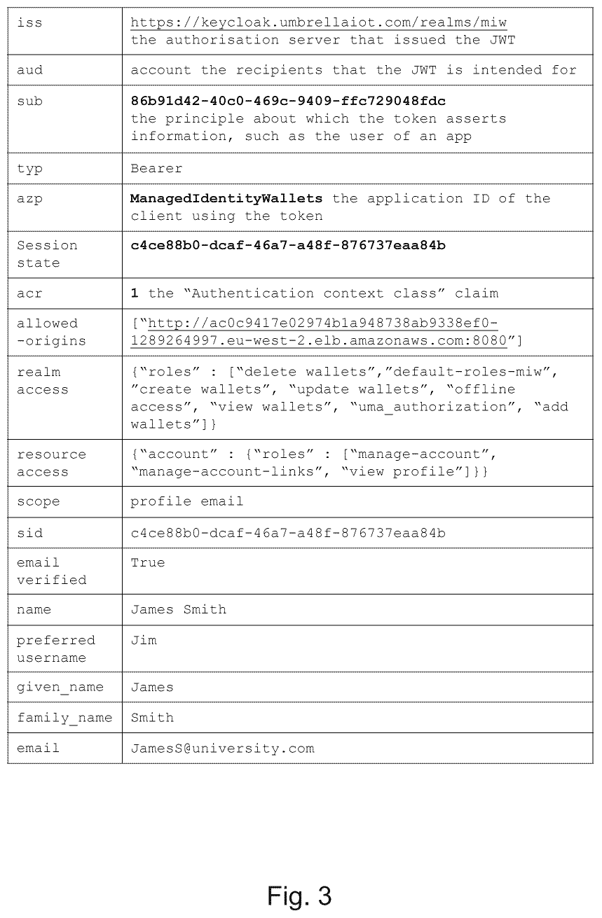

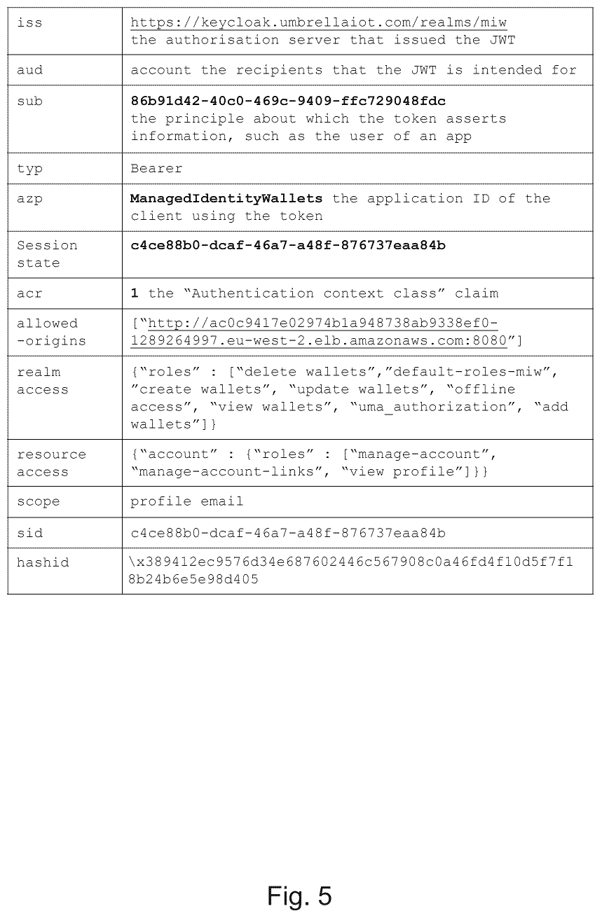

In step S419, the user incorporates the hashID and the authorization code in an access token that is communicated to the local (Domain A) authenticator. FIG. 5 shows an example of the access token as used in the embodiment of FIG. 4. In contrast to the conventional federated ID token of FIG. 3, which contains the user personal identification attributes (name, email address), the hashID in the access token of FIG. 5 is fully anonymised.

Still referring to FIG. 4A, in step S421, the authenticator reconstructs the hashID using the stored value of the location-dependent parameter and timestamp. If the reconstructed hashID matches that hashID received from the user, the authenticator is able to verify the user. The authenticator performs a join query on the usermap and the attribute data tables stored in the attribute database in order to resolve the data relating to the user, using the hashID as a temporary identity reference for the user.

Following this, the Domain A authenticator provides the user with the further access token (step S433), allowing the user to access the client Domain A (see steps S435, S437 of FIG. 4B). Continuing with FIG. 4B, the user may request and acquire access to the second domain (domain B) using a similar sequence of steps to that of FIG. 4A, the exception being that the IdP does not need to authenticate the user's credentials following step S445, since the credentials were previously authenticated in step S411 of FIG. 4A.

Returning to FIG. 4A, if the verification in step S421 is unsuccessful (step S423), the method proceeds to step S425 in which the Domain A authenticator uses the authorization code received in step S419 to obtain an ID token from the Keycloak IdP. The IdP updates the usermap (location) in the Domain A attribute database (step S427) and provides the ID token to the Domain A authenticator (step S429). The Domain A authenticator performs a lookup using attributes from the ID token to match with the attributes in the attribute database (step S431). Following this, the Domain A authenticator provides the user with the further access token (step S433), allowing the user to access the client Domain A (see steps S435, S437 of FIG. 4B).

It will be appreciated that the access token as sent to the authenticator in step S419 already contains identity information, which is anonymised in the form of the hashID, and which makes it possible to authenticate the user without the need to exchange the ID token between the authenticator and the IdP Keycloak. Thus, steps S423 to S431 of FIG. 4A need only be carried out in the event of failure in step S421; there will be no need to obtain the separate ID token from the IdP (step S425) if the location has already been successfully propagated in steps S421.

Accordingly, in the method of FIGS. 4A and 4B, the user's location is anonymously provided to the cross-domain services using the hashID and compared with data obtained via the client applications within those domains (such as location-based promotion apps) without the applications themselves needing to reveal the true user identity through the cross-domain login process. Hence, the applications can provide anonymised but personalised cross-domain services using the hashID containing location, together with a timestamp (or other attribute). The user can then be associated with the unique location fingerprint even if other attributes do not match or are duplicated within domains. Providing that it is highly improbable that two users with the same surname/family name share the exact same location at the same time this approach permits uniqueness and does not depend solely on the absolute accuracy of the location.

It will be appreciated that if the user's hashID is not already provisioned in a particular domain when a verification request is made, a new hashID will need to be provisioned before the verification process can be carried out. Therefore, upon receipt of a verification request (e.g. step S421 in FIG. 4A), a check may be made for the existence of a prior hashID in the attribute database(s). If there is no prior hashID, then the IdP will perform a bootstrap operation in which it creates new entries for the hashID in the local domains' usermaps as stored in the attribute databases. The new entry in each database can then be mapped when the user next uses the application from the relevant domain. For instance, when the user next uses the application provided by Domain A in the conventional way, it will update the usermap mapping and permit the login steps to enable the anonymous login.

The hashID will need to be recomputed if the user session has expired with the IdP or the location has changed from when the last login sequence took place. The value of the location-dependent parameter and corresponding hashID can be updated periodically when an active session is ongoing. For instance, every minute. When retrieving the first data from user agent it is normal to specify how frequently updates are to be made, and at what spatial resolution. For example, the Javascript code may include an instruction to update the first data—and by extension, the value of the location-dependent parameter—every minute, with either fine or coarse spatial resolution.

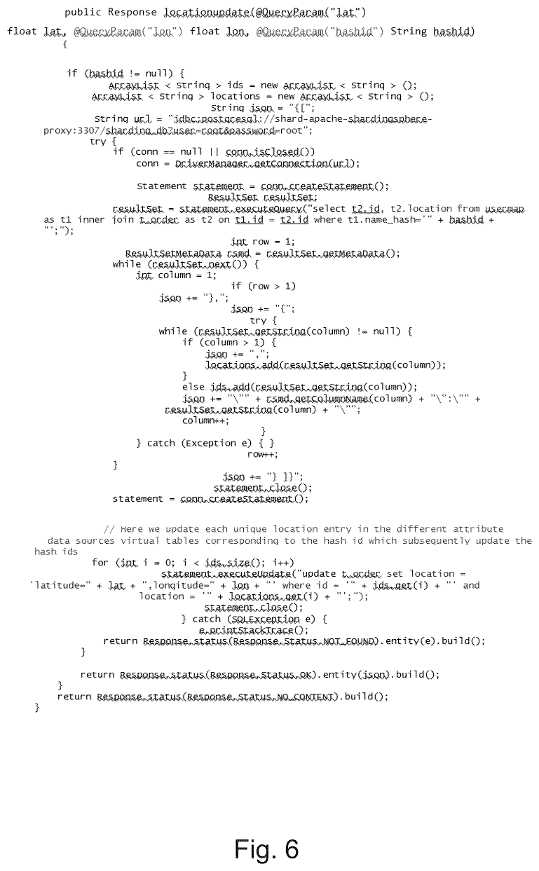

The user's location can be updated by the local domain authenticator whenever a new cross domain login occurs and can be verified with the hashID by computing the hash of the location-dependent parameter and timestamp obtained in that domain. The location updates may be subsequently propagated to the different data sources in the relevant domains that require location information to update hashIDs and verify mapping when joined queries are performed on cross-domain attributes. FIG. 6 shows an example sequence of code for anonymously updating the location-dependent parameter held in the virtual tables in the attribute databases. In this example, the domain specific user map tables are used to map the hashID to the local domain IDs which are then used to update the virtual table (called t_order). In this manner the application client only knows the hashID and location dependent parameter, but not the real IDs or other personal attributes of the entries in the t_order virtual tables. The hash ID is passed within the client embedded code that is either called in the login script or the client application page. The location update then reports back to the location handler in the login domain (i.e. such as proxy.domainA.com or proxy.domainB.com).

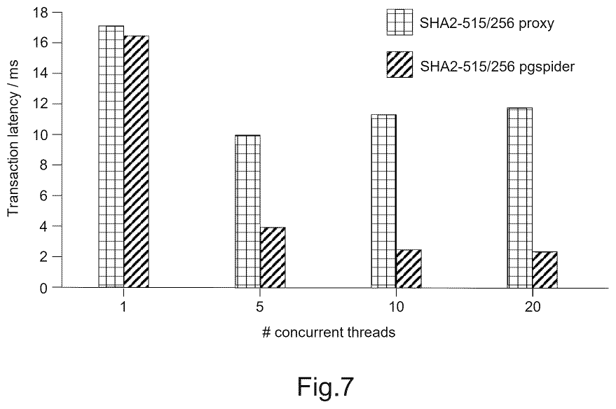

In some embodiments, a proxy broker may act as an intermediary between the application running on the end user device(s) and the identity provider (IdP) and cross-domain services. The interactions with the cross-domain attribute stores are handled by the proxy broker. The performance of queries are illustrated in FIG. 7 for two approaches with a distributed database proxy (sharding sphere proxy) and without (pgSpider). This illustrates the performance impact of using a database proxy, when there are high numbers of concurrent transactions, but with the advantage of not requiring modification to existing applications or database infrastructure holding the user data.

In a further embodiment it is possible to use a distributed ledger to propagate the updates in the value of the location-dependent parameter across domains rather than or in addition to conventional distributed databases such as sharding sphere or pgspider. Also, multiple hashIDs can be generated to correspond to the same user in order to control the scope of the cross-domain data sharing. In this manner, if the user only consents to attribute data to be shared between domain A and B a unique hashID may be generated for domain A and B, without that hashID being used for other domains.

In a further embodiment, the hashIDs can be embedded in advertisement URIs with smart (digital) receipts that are delivered to end users in order to support cross-domain advertisements without disclosing personal identifiers or attributes. In this case the login only requires location/timestamp information and the last hash ID computed from the previous update, which is stored in the browser or application.

Thus, embodiments enable provide a universal method to perform and verify a user identity mapping across multiple domains, based on user location. In combination with a timestamp attribute, this can uniquely identify the user, via the location of the end device they are using, and allow verification of the mapping to actual user identities in the domain.

Embodiments described herein provide a low complexity, high performance method of cross-domain mapping and verification of user attribute data. Embodiments can also permit mapping even without unique cross-domain attributes while preserving user privacy by updating the hashed location/timestamp.

Embodiments described herein do not require any additional mechanisms apart from the inclusion of location derived from the user device on which the application interaction resides. Hence, any user with the same identity attribute or attribute set in a different location will not be verified and mapped as the same user. Meanwhile, a domain that does not have available all the same attributes as another (such as email or passport number) can still be mapped to the user even if the personal attributes themselves cannot be directly shared.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

While certain embodiments have been described, these embodiments have been presented by way of example only and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

1. A computer-implemented method comprising:
receiving, by a first domain attribute database from a user device, first data;
determining, based on the first data, a value of a location-dependent parameter for the user device;
computing, by the first domain attribute database, a first hashID for a user of the user device, based on the value of the location-dependent parameter;
mapping, by the first domain attribute database, the first hashID to one or more user attributes stored in the first domain attribute database;
receiving, by the first domain attribute database from an authenticator for the first domain, a lookup request comprising a second hashID;
in the event that the first domain attribute database determines the second hashID to match the first hashID, using the mapping between the first hashID and the one or more stored user attributes to return the one or more stored user attributes.

2. A computer-implemented method according to claim 1, further comprising:
forwarding, by the authenticator for the first domain to the user device, an access token with which to access the first domain.

3. A computer-implemented method according to claim 1, wherein the first hashID is computed by the first domain attribute database using the value of the location-dependent parameter and a timestamp indicating a time of receipt of the value of the location-dependent parameter by the first domain attribute database.

4. A computer-implemented method according to claim 1, comprising:
receiving, by the first domain attribute database, at a later point in time, an updated value of the location-dependent parameter for the user device; and
re-computing the first hashID using the updated value of the location-dependent parameter.

5. A computer-implemented method according to claim 4, wherein the re-computed first hashID is computed using the updated value of the location-dependent parameter and a timestamp indicating a time of receipt of the updated value of the location-dependent parameter by the first domain attribute database.

6. A computer-implemented method according to claim 5, wherein in the event that the first domain attribute database fails to match the second hashID with the first hashID or any other previously received hashID, the method comprises:
issuing, by the authenticator for the first domain, a request for an ID token from a federated identity provider with whom the user has previously authenticated themselves;
receiving, by the authenticator for the first domain, the ID token and;
performing, by the identity provider, a location update using the first hashID on the first domain attribute database; and
performing, by the first domain attribute database, a lookup of the one or more stored user attributes using the hashID attributes from the ID token; and
returning, by the first domain attribute database, the one or more stored user attributes to the authenticator for the first domain.

7. A computer-implemented method according to claim 6, further comprising:
receiving, by the first domain attribute database from the federated identity provider, an updated value of the location-dependent parameter for the user device.

8. A computer-implemented method comprising:
providing, by a user of a user device to a federated identity provider, user authentication credentials and a value of a location-dependent parameter;
receiving, by the user device from the federated identity provider, and in response to being authenticated by the federated identity provider, a first hashID, the first hashID being computed based on the value of the location-dependent parameter;
forwarding, by the user device, the first hashID to an authenticator for a first domain; and
receiving, from the authenticator for the first domain, an access token with which to access the first domain.

9. A computer-implemented method according to claim 8, wherein the first hashID is computed based on the location data and a time at which the value of the location-dependent parameter was forwarded to the federated identity provider.

10. A computer-implemented method according to claim 8, further comprising:
providing, by the user of a user device to the federated identity provider at a subsequent point in time, an updated value of the location-dependent parameter;
receiving, by the user device from the federated identity provider, a second hashID, the second hashID being computed based on the updated value of the location-dependent parameter;
forwarding, by the user device, the second hashID to an authenticator for a second domain; and
receiving, from the authenticator for the second domain, an access token with which to access the second domain.

11. A computer-implemented method according to claim 10, wherein the second hashID is computed based on the updated value of the location-dependent parameter and a time at which the updated value of the location-dependent parameter was forwarded to the federated identity provider.

12. A computer-implemented method according to claim 1, wherein the value of the location-dependent parameter is propagated to the first domain attribute database via a network hosting a distributed ledger.

13. A computer system comprising one or more computing devices configured to execute the method according to claim 1.

14. A non-transitory computer readable medium comprising computer executable instructions that when executed by one or more computing devices will cause the one or more computing devices to carry out the method of claim 1.
